(19) United States
(12) Patent Application Publication
(10) Pub. No.: US 2008/0167998 A1
(43) Pub. Date: Jul. 10, 2008

(54) Online healthcare system and methods

(76) Inventor: Robert B. Hyte, Draper, UT (US)

Correspondence Address: THORPE NORTH & WESTERN, LLP., P.O. Box 1219, SANDY, UT, 84091-1219, US

(21) Appl. No.: 11/975,128

(22) Filed: Oct. 16, 2007

Related U.S. Application Data
(60) Provisional application No. 60/852,036, filed on Oct. 16, 2006.

(51) Int. Cl. G06Q 50/00; G06Q 20/00

(52) U.S. Cl. 705/80; 705/3

(57) ABSTRACT

An online healthcare method provides online health care from a healthcare provider to a patient online, comprising: (a) providing online communication between the patient and the healthcare provider; (b) providing online diagnosis and treatment by the provider for the patient; and (c) providing the user's medical records online to be accessed by the patient and the healthcare provider in providing online diagnosis and treatment. The online healthcare method also comprises providing an online offer from the patient to the healthcare provider to pay a predetermined amount for a medical procedure desired by the patient; and providing an online reply from the healthcare provider to the patient accepting, denying, or countering the offer from the patient.

### PRIORITY

This application claims priority to U.S. Provisional Patent Application entitled “Online Healthcare System and Methods” filed on Oct. 16, 2006 for an on behalf of Robert B. Hyte of American Fork, Utah. Said application is incorporated herein in its entirety by reference.

### FIELD

This application relates to online healthcare systems and methods. More particularly, this application concerns an online healthcare system having means to enable a user to establish and communicate with healthcare providers, healthcare insurers, health savings accounts and health procedure financing.

### BACKGROUND

As we move into the 21st century, the U.S. healthcare system is struggling. Medical costs and insurance costs are rising substantially faster than the cost of living or increase in income. A greater percentage of the population has reached retirement age, with fixed incomes that cannot handle these increases. Managed care organizations, like HMOs, PPOs, and other medical insurance providers have increasingly taken over the medical profession, dictating when medical services will be given, who will do them, and how much will be charged. While overhead continues to increase, managed care providers limit the services that healthcare professionals can provide, impacting their ability to compete.

The consumers are also unhappy with the healthcare system, as insurance premiums rise, services are reduced and personal choice is restricted. Employers are capping or even eliminating their contributions to medical insurance. Millions of Americans are uninsured or minimally insured, as the system becomes less available at today's prices.

In 2003, Congress responded to these problems by providing the opportunity for families to establish Health Savings Accounts (HSA). First, they must enroll in a qualified high deductible health plan (HDHP) which provides coverage for catastrophic illnesses, while keeping premiums relatively low. The consumer is able to contribute to the HSA from pre-tax dollars deducted from his payroll income. The HSA pays for all medical expenses not covered by the HDHP. Since the consumer is paying, he is able to take control back of his medical destiny, determining what medical services are provided by whom and when.

Although these developments have been helpful, it is difficult for a consumer to navigate the complex landscape of setting up the right HDHP and HSA to be able to utilize the new freedom that has been provided. Also, he now has more freedom to select a physician and other healthcare providers, but this requires time to look for suitable service providers. Greater information is needed by the consumer to make appropriate decisions in these areas. Information technology, including the internet, must play an important role is enabling the consumer to establish his custom-made healthcare program.

A few internet-related procedures have been developed for healthcare providers. U.S. Published Patent Application 2002/0065758 (Henley) discloses an online auction system allowing prospective patients to bid on proffered services of professional services providers. U.S. Pat. No. 6,006,191 (DiRenzo) shows a system for patients to bid on physicians' services of diagnosing electronic medical images. U.S. Published Patent Application 2002/0128879 (Spears) shows an online system for providing and coordinating personalized healthcare and insurance information to assist a consumer in coordinating with his employer to customize his benefits plan.

None of the foregoing documents disclose a comprehensive online system for handling all necessary aspects of a customized healthcare plan for each consumer—including establishing an HDHP insurance plan, an HSA to coordinate therewith, various discounts for healthcare professionals, pharmaceuticals and dietary and nutritional supplements, online means for learning about and selecting suitable healthcare providers, provisions for negotiating the charges and times for the delivery of healthcare services, online avenues for financing when necessary, family wellness coordination, and medical records online access for both the patient and the physician.

### SUMMARY

In one embodiment of the present implementations, an online healthcare method is provided, comprising (a) providing online communication between the patient and the healthcare provider; (b) providing online diagnosis and treatment by the provider for the patient; and (c) providing the user's medical records online to be accessed by the patient and the healthcare provider in providing online diagnosis and treatment.

In another embodiment of the present implementation, an online healthcare method provides online health care from a healthcare provider to a patient, comprising (a) providing online communication between the patient and the healthcare provider; (b) providing an online offer from the patient to the healthcare provider to pay a predetermined amount for a medical procedure desired by the patient; and (c) providing an online reply from the healthcare provider to the patient accepting, denying, or countering the offer from the patient.

In another embodiment of the present implementation, an online healthcare method provides online health care from a healthcare provider to a patient, comprising (a) providing an online network of healthcare providers; (b) searching the online network to find a suitable healthcare provider for the patient; (c) submitting an online request from the patient to hire the healthcare provider; and (d) submitting an online reply from the healthcare provider accepting or denying the request from the patient.

### BRIEF DESCRIPTION OF DRAWINGS

FIG. 1A is a block diagram illustrating the functions of an online healthcare system, according to one embodiment;

FIG. 1B is a flow diagram showing an overview of the various functions of the embodiment of FIG. 1A;

FIG. 2 is a flow diagram showing the functions of the health discount services, according to the embodiment of FIG. 1B;

FIGS. 3A and 3B are flow diagrams showing the functions of the online health consultations, according to the embodiment of FIG. 1B:

FIG. 4 is a flow diagram showing the functions of the online doctor-patient matching and bidding services, according to the embodiment of FIG. 1B;

FIG. 5A is a flow diagram showing the functions of the online patient assistance services, according to the embodiment of FIG. 1B;

FIG. 5B is a flow diagram showing the functions of the online patient financing services, according to the embodiment of FIG. 1B;

FIG. 6 is a flow diagram showing the functions of the high deductible health plan insurance services, according to the embodiment of FIG. 1B;

FIG. 7 is a flow diagram showing the functions of the health savings account services, according to the embodiment of FIG. 1B;

FIG. 8 is a flow diagram showing an overview of the functions of the healthcare provider's services, according to the embodiment of FIG. 1B;

FIG. 9 is a flow diagram showing the functions of reading and answering patient offers, according to the embodiment of FIG. 8;

FIG. 10 is a flow diagram showing the functions of reading and answering patient email consultation requests according to the embodiment of FIG. 8;

FIG. 11 is a flow diagram showing the functions of reading and answering patient email requests to refill prescriptions, according to the embodiment of FIG. 8;

FIG. 12 is a flow diagram showing the functions of reading and answering patient's appointment requests, according to the embodiment of FIG. 8;

FIG. 13 is a flow diagram showing the functions of reading and answering patient notes, according to the embodiment of FIG. 8; and

FIG. 14 is a flow diagram showing the functions of editing provider profiles, according to the embodiment of FIG. 8.

### DETAILED DESCRIPTION

The present implementation, referred to herein as the Direct Access System, involves an online internet portal that enables users to access healthcare products and services directly and to interrelate the user with selected healthcare providers, healthcare insurers, health savings accounts (HSA), and other related goods and services. The present implementation also enables an online user to seamlessly obtain healthcare insurance, a health savings account, and a medical discount account.

Using the Direct Access System of the present invention, a user may contact healthcare providers and establish a relationship online under mutually acceptable financial terms. It also enables a user to use the internet to make appointments with healthcare providers and obtain discount coupons for use during the visits. The present implementation enables a user to visit with a healthcare provider online for certain diagnoses and medication where a face-to-face visit is unnecessary. The present implementation also enables the user to secure a high-deductible, health plan (HDHP) using a selected insurer, to obtain a health savings account (HSA), and if necessary obtain financial assistance in carrying out medical procedures. According to the present implementation, a user may also obtain a medical discount card that enables the user to a number of discounts and benefits through a network of healthcare providers.

The Direct Access System enables a user to take personal control of financial expenses and medical care decisions. Rather than allowing an HMO to decide which physician he sees and what medical care he will be able to receive, he is able to make those decisions for himself and decide when, where, and how to spend his hard-earned funds. He is also able to use pre-tax dollars for those medical expenditures. It is understood that some of these features are available to the public without using the Direct Access System. Part of the value and uniqueness of the present implementation is that a user is provided with direct access to all of these public programs and much more in a single unified online system to enable and expedite healthcare services.

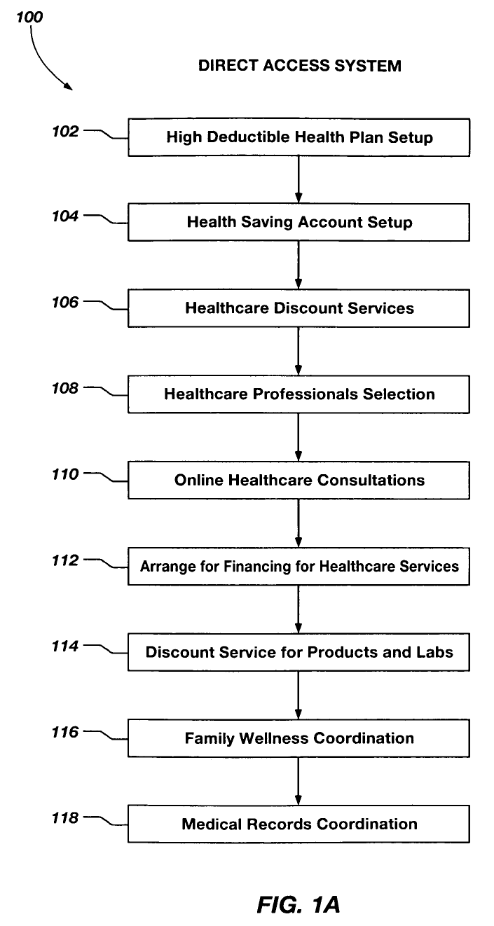

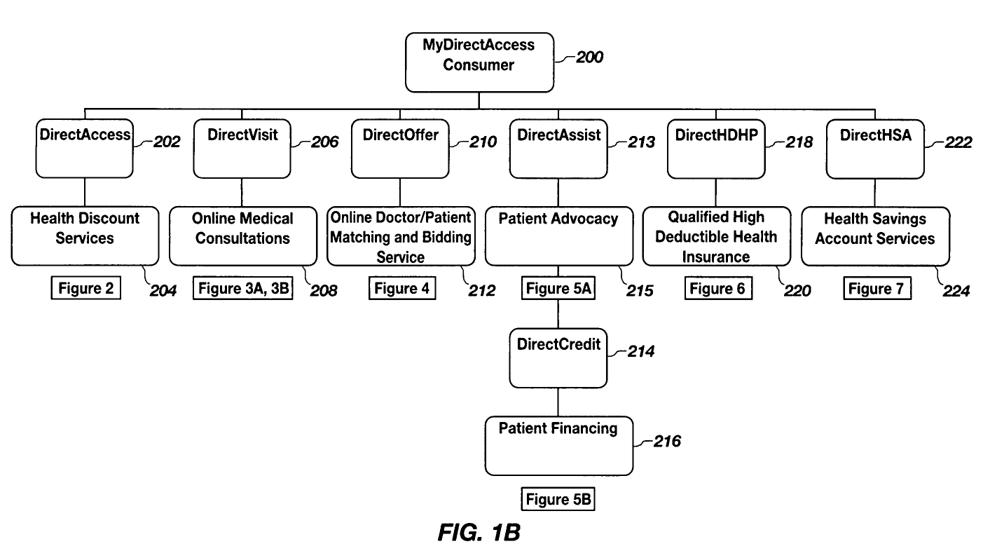

Referring first to FIG. 1A, a block diagram 100 shows the main steps of the present implementation of the Direct Access System in one possible sequence of execution. The method may be carried out in different sequences or may omit one or more steps. At the first step 102, the Direct Access System directs the user to one or more separate and independent companies to establish a high deductible health plan (HDHP). An HDHP program will primarily provide medical insurance coverage for large medical expenses, while routine and minor procedures will be paid for directly by the consumer. This approach enables the consumer to reduce his healthcare insurance premiums dramatically, while maintaining coverage for catastrophic illnesses. The savings in insurance premiums can be invested tax-free in a health savings account and used for a variety of medical expenses.

Next, at 104, the user is directed to one or more programs to provide a health savings account (HSA). Typically, a government program allows the establishment of such an HSA account only after an HDHP has been set up. This HSA account may be funded by pre-tax money from an employer or independent consultant which is taken out of earnings prior to the withdrawal of state and federal payroll taxes. These pre-tax funds are placed in an HSA account, and the user is provided access to the account by a debit card to charge health expenses as they are accrued. Any funds that are not spent on medical care in a given year may be carried over year after year or can be used for retirement savings.

At step 106, the Direct Access System gives the user access to a variety of healthcare discounts through a Direct Access Discount card. Deep discounts are provided for healthcare providers, such as medical, dental, chiropractic, vision, hearing, and prescription medication. Users of the Direct Access System are plugged into a network providing substantial savings in all of these areas.

At step 108, the Direct Access System enables a user to search for a suitable doctor for his needs at an agreeable price. The Direct Access System establishes a network of physicians at reduced rates, saving substantial charges compared to normal fee schedules. Users are able to search for physicians that best meet their overall needs, by reviewing on the network a variety of physician information, including expertise, training, experience, schedule of charges, address, availability, and so forth. Once a physician is selected, a user may make an initial appointment online and may print out all important information, as well as discount coupons for the first and subsequent visits.

At step 110, a user is provided with direct online consultation with a physician regarding minor and routine medical problems. This approach eliminates personal physician visits for routine problems that can be taken care of over the internet, thereby reducing costs to the user. This approach also speeds up the treatment process so that health issues can be quickly handled without waiting for a future doctor's visit. The System also enables an attending physician to respond quickly at any convenient time rather than trying to crowd in all patients in his office schedule. The user also eliminates costly waiting and irritating time often needed to see a physician.

At step 112, a user is given access to financing services, which can be coordinated with his HSA account to provide the funds needed for expensive medical procedures that may be required.

At step 114, after medical consultation and treatment, the user is provided with discounts for follow up pharmaceuticals, laboratory procedures, nutritional supplements, and health and beauty products. The Direct Access System connects a user into a network of online stores and services that provide substantial savings. Free or discounted laboratory procedures are also provided, such as online blood screening for cholesterol, chemicals, and CBC.

At step 116, the Direct Access System enables a user and his family to use a fitness and nutrition tracking system for help with weight loss, exercise, and managing medical conditions. The user is also provided with a variety of wellness information, including healthy meal planning and recipes, graphing, goal setting, and chatrooms.

Finally, at step 118, the user is enabled to store and easily access a variety of his family's personal health and medical records. Access is carefully controlled by the user, who can give his physicians and other healthcare providers limited, but easily retrieved access to his health and medical records.

Referring now to FIG. 1B, a flow chart 200 is shown giving an overall view of another format or implementation of the Direct Access System from a consumer or patient viewpoint. Here, the functions of the system are separated into six different steps, each being explained more fully in subsequent FIG.s. These steps and their functions are referred to as DirectAccess at 202—providing healthcare and pharmaceutical discount services at 204, DirectVisit at 206—providing online medical consultations at 208, DirectOffer at 210—providing online doctor-patient matching and bidding services at 212, DirectAssist at 213—providing patient advocacy at 215, DirectCredit at 214—providing patient financing at 216, DirectHDHP at 218—providing qualified high deductible health plan insurance at 220, and DirectHSA at 222—providing health savings account services at 224.

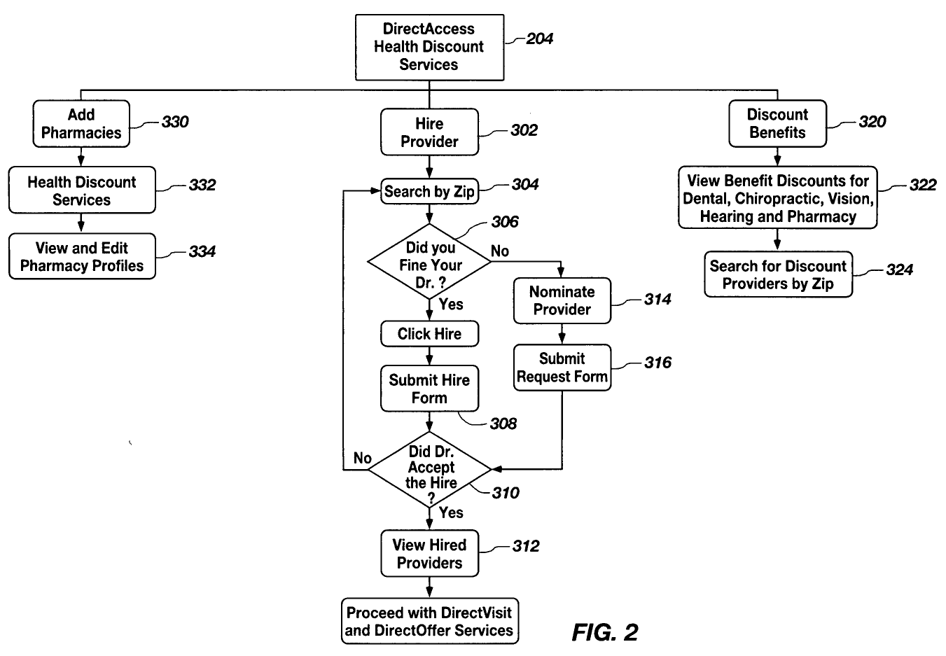

Looking next at FIG. 2, the DirectAccess health discount services 202-204 are shown in more detail. Consumers are able to use the tools to engage medical providers that are listed in the database, search for medical providers offering discounts and add their chosen pharmacies to the database. At step 302, the user is directed to hire a healthcare provider from a network of providers. As stated earlier, various searches at step 304 may be carried out to find a provider that is suitable to the needs of the user, including searches regarding expertise, training, experience, schedule of charges, address, and availability.

At 306, the user is asked if a doctor was found. If so, at 308, the user submits a hire form to the physician's office, proposing a doctor-patient relationship. At 310, the user determines whether the doctor accepted his offer. If so, the user views his update of selected provider list at 312 and then moves on. If the doctor did not accept the offer, then the user returns to the search block 304 to look further for a doctor. If the user is unable to locate a doctor in the system, then at step 314, he may nominate a provider to be included in the network and may submit a request form at 316 offering to hire the provider. If the new provider accepts the offer at 310, then the provider list is updated at 312.

At step 320, the user may locate discount benefits for healthcare services. At step 322, the user searches for discount benefits provided by the System, including discounts for dental, chiropractic, vision, hearing, and pharmacy services. At step 324, the user may search for ancillary discount providers, such as chiropractic, vision, hearing, dental, pharmacies, and so forth. Searching may be carried out however the database allows, including by ZIP code.

Next, at step 330, the user may add a preferred pharmacy to the discount network database by submitting a pharmacy profile at step 332. This pharmacy may later be selected during refill requests. Then, at step 334, the user may view and edit pharmacy profiles.

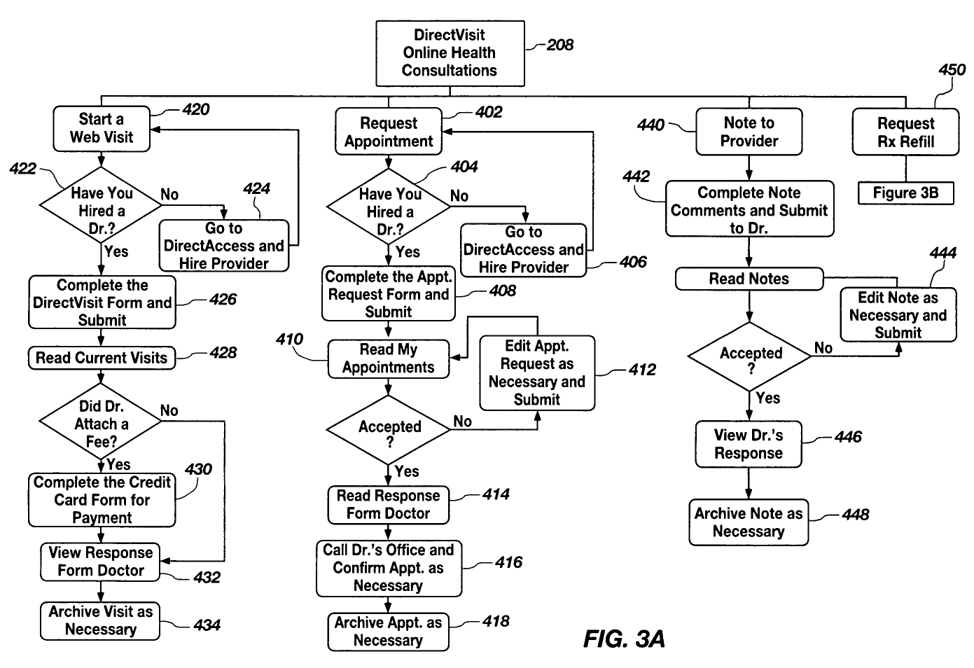

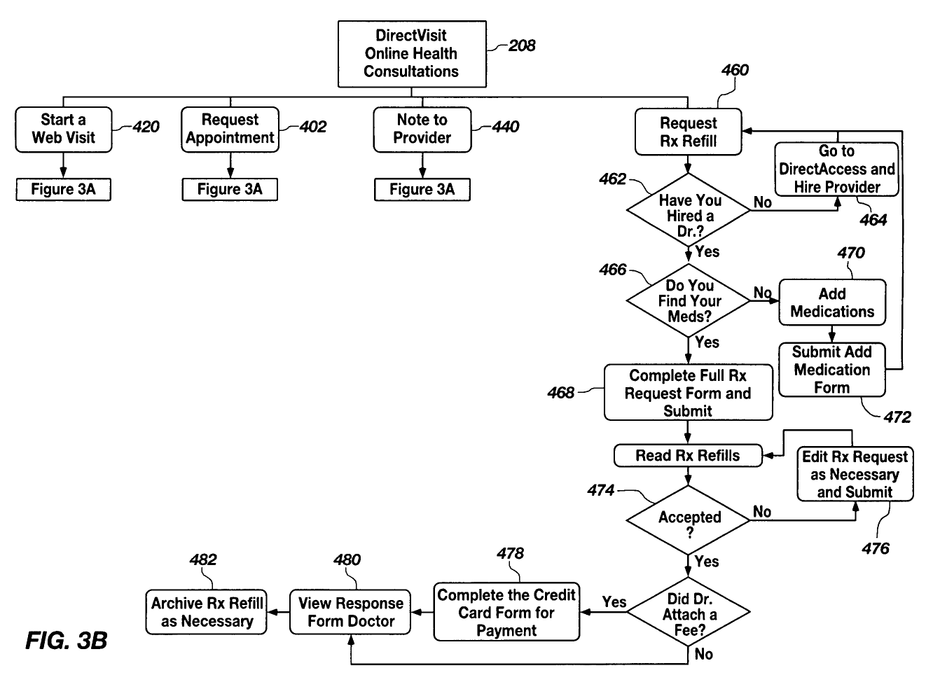

Referring now to FIGS. 3A and 3B, the DirectVisit online health consultation services 206-208 are shown in more detail. This part of the Direct Access System may be utilized to set up an office visit with a physician, carry out an online visit, submit notes and other information to a doctor, and request prescription refills from a selected medical provider. Looking first at FIG. 3A, a user starts the appointment process at step 402. At 404, the system asked if a doctor has been hired. If not, the user is directed at 406 to the DirectAccess portion of the System 204, where the doctor hiring process is conducted.

If a doctor has been engaged then at 408 the user completes an appointment request form and submits it to the doctor's office. The user then reads his appointment schedule at 410 and if the appointment has not been accepted, he may revise his request and resubmit the appointment request at 412. If the appointment has been accepted at 414, the user may call and confirm at 416 and enter the appointment into his schedule or otherwise archive the appointment at 418.

In the event that the user desires to start an online visit at 420, the system at 422 inquires as to whether he has hired a doctor. If not, at 424 he is directed to the DirectAccess portion of the System 204, where the doctor hiring process is conducted. Otherwise, the user completes the online request form describing the diagnosis or other information requested from the doctor and submits it to the doctor, at step 426. Then, at step 428, the user determines whether the visit has been accepted. If a fee is required, the user may submit credit card information at 430. The doctor's response is then viewed at 432 and the visit information is archived at 434.

The user may desire to provide a note to the doctor, at step 440. The note may be feedback regarding the online treatment, or other information regarding the condition of the patient. The note comments are submitted to the doctor, at 442, they may be edited first at 444. The doctor's response is viewed at 446 and archived if necessary, at 448. In the event that a prescription refill is requested, the process goes to FIG. 3B.

FIG. 3B shows a process at 460 for online requests for refilling prescriptions. The system at 462 asked if he has hired a doctor. If not, at 464 he is directed to the DirectAccess portion of the System 204, where the doctor hiring process is conducted. Otherwise, at 466, the System looks for the medical prescription records of the user. If found, then at 468, the user submits to the doctor a request for a refill of the prescription. If the medicine needed is not found in the prescription records, then the medications are added at 470 and a request is submitted to the doctor at 472 for a new prescription. The system then goes to step 460 to get the new medication.

If the refill request is not accepted at 474 then the user edits the request at 476 and resubmits the request. If it is accepted and the doctor attached a fee, then, at 478 the user provides credit card information to pay for the charge. The doctor's response is viewed at 480 and the refill information is archived at 482.

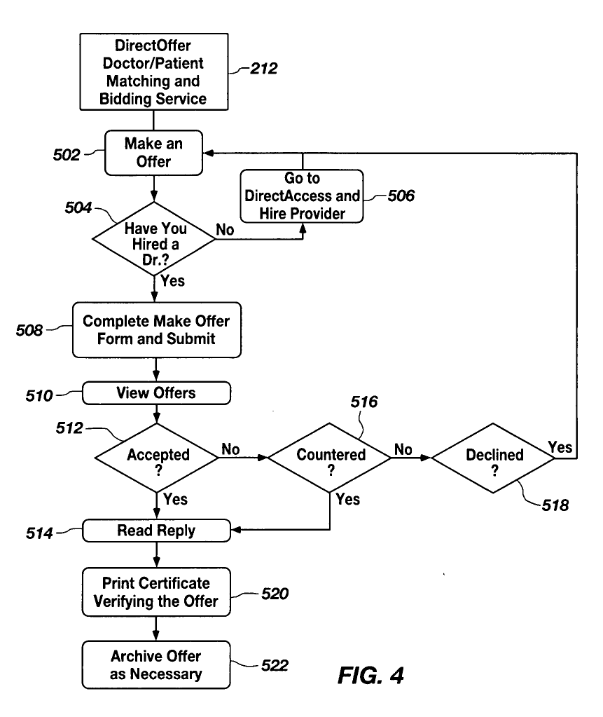

Referring now to FIG. 4, the DirectOffer doctor/patient matching and bidding services 210-212 are shown in more detail. This part of the Direct Access System may be utilized to make an offer to a physician for specific medical services. The selected medical provider may either accept, counter, or decline the offer. Although the offer may be less than a doctor's standard schedule, this gives the doctor an opportunity to determine whether his time schedule would allow him to accept the offer during regular hours or to schedule the visit during an otherwise downtime or slow period.

At step 502, a user makes an offer to a doctor for services. At 504, the system asked if a doctor has been hired. If not, the user is directed at 506 to the DirectAccess portion of the System 204, where the doctor hiring process is conducted. If the doctor has been hired, the offer is completed and submitted at 508. The user then views offers at 510 and determines whether the offer has been accepted at 512 by reading the reply at 514. If the offer was not accepted, the user may determine whether a counter offer was submitted by the doctor at 516. If so, the user may accept it and read the reply at 514. If the offer was declined at 518, the user may make a new offer at 502. The user may print an accepted offer at 520 and archive the offer at 522 if desired.

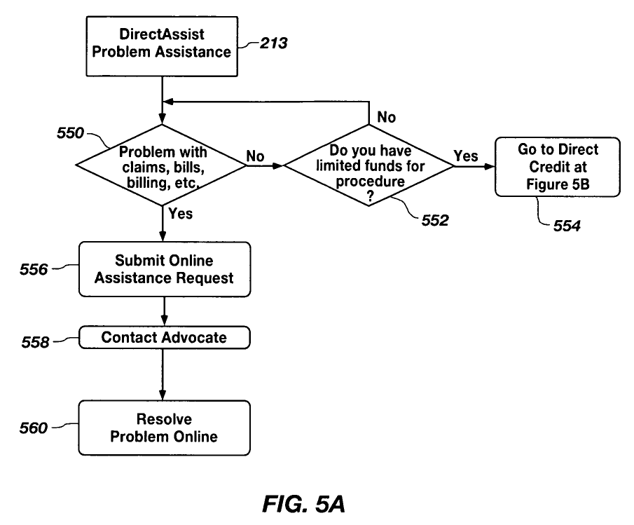

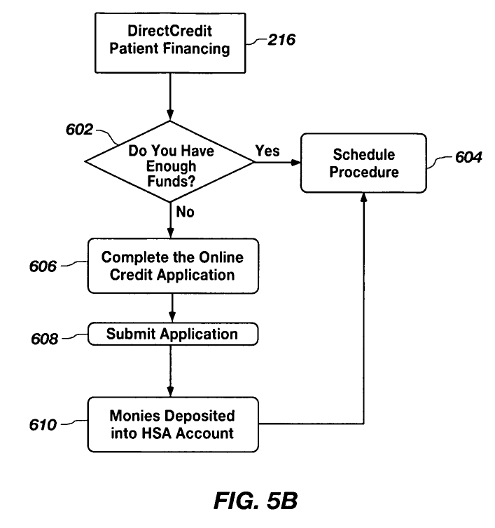

FIG. 5A shows the DirectAssist patient advocacy function 213 in more detail. This set of online tools enables a member/patient to obtain online assistance for a number of problems, such as healthcare bills, claim denials, billing overcharges, payment arrangements, and other clinical issues. These tools of the Direct Access System help the member to negotiate with the healthcare providers, the HSA entity, and the insurance system. The healthcare advocate functions much like a concierge in a luxury hotel with the expertise to solve problems and provide effective solutions with regard to the member's healthcare issues.

At step 550, a query is made regarding problems or issues being encountered by a member/patient. If not, a query is made as to whether there are sufficient funds for a suggested procedure, at step 552. If there is a problem with funding, then the process goes directly to the DirectCredit utility described in FIG. 5B. If the query at 550 is positive, then the member/patient submits an online assistance request, at step 556. An appropriate advocate is contacted by the system at step 558, who then takes whatever action may be needed to resolve the problem online 560.

FIG. 5B shows the DirectCredit patient financing services 216 in more detail. Consumers are able to complete an online application for healthcare credit through this web portal. First, a determination is made at 602 regarding whether the user has sufficient funds to carry out a medical procedure or otherwise pay for medical services or products. If so, then the procedure is scheduled at 604. If not, then an online credit application is completed at 606 and submitted at 608. When the necessary funds are received they are deposited in the user's HSA account at 610. If the credit submission is refused, the user goes back to step 606 and completes an application to another credit entity.

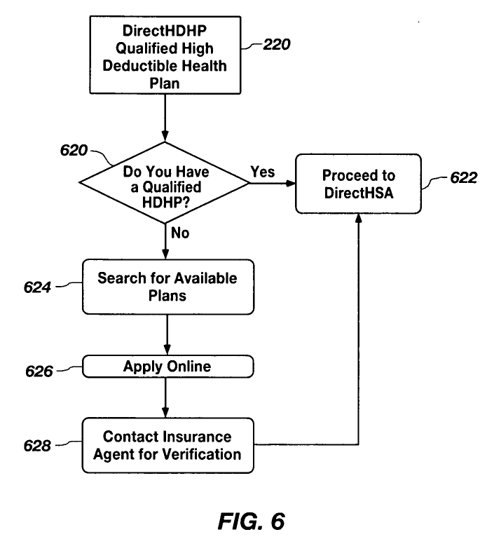

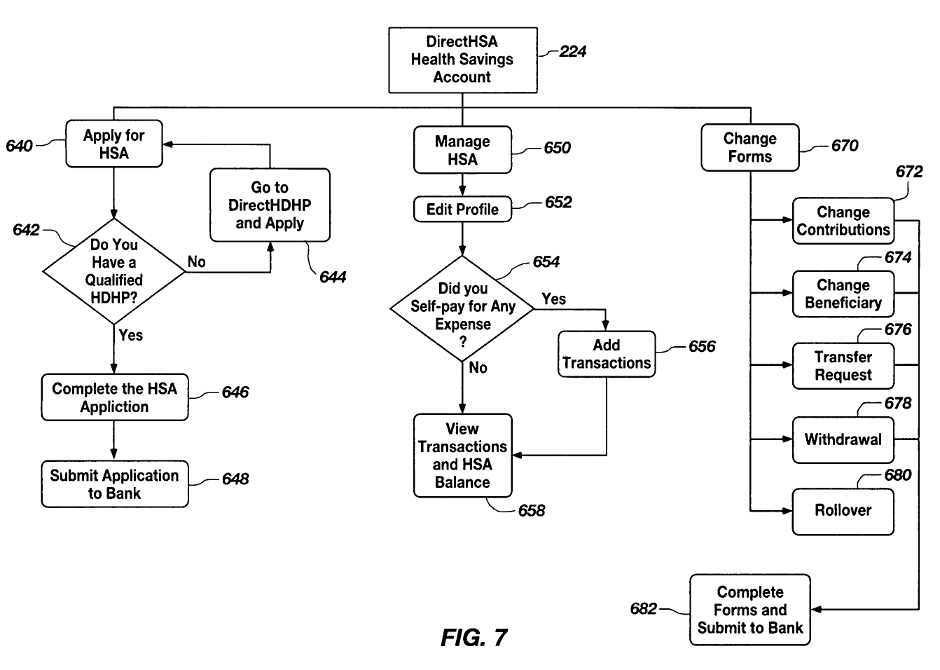

Referring now to FIGS. 6 and 7, the Direct Access System portion 220 dealing with obtaining a qualified high deductible health plan is covered in greater detail. A consumer is enabled to search for and apply for the health plan of his choosing by using the Direct Access System tools contained in this tool set.

If it is determined at 620 that the user already has a qualified high deductible health plan, then the user proceeds at 622 directly to the HSA portion 224 of the Direct Access portion of the System. If not, then the user utilizes the Direct Access System to conduct an online search at 624 of available plans for available systems. The user selects an HDHP and submits an online application at 626 and later contacts an agent at 628 to verify that he has been accepted. If so, he proceeds via 622 to the HSA process. If not, he returns to 624 to search for other available plans.

The Direct Access System portion 224 dealing with establishing a health savings account is shown in more detail. A consumer is able to download an application to apply for a health savings account (HSA). Once a member has opened an HSA, the Direct Access System tools enables the consumer to change his contributions or beneficiaries, make transfers, withdrawals, or rollovers by completing the appropriate forms. The tool set also includes a direct link to the custodial bank, enabling a member to manage his HSA funds online. He is able to view all of his transactions, make transfers, withdrawals, and deposits on this secure portal.

First, at step 640, the user applies online for a health saving account with a qualified bank or other qualified institution. Before doing so, a determination is made at step 642 as to whether the user has a high deductible health plan. If not, step 644 directs him to the DirectHDHP portion 220 of the Direct Access System. If the user has a HDHP, then the user completes an online HSA application at 646 and submits it at 648 to a bank or other qualified institution.

Once an HSA is obtained, then the user must manage the account at 650. At 652, he edits the profile of the HSA. At step 654 he determines whether he self-paid for any qualified expense. If so, he adds the expense to the HSA transactions, at 656. The user is then able to view at 658 an update of all transactions and the HSA balance.

This part of the Direct Access System also enables a user to change forms at 670 in the HSA. These form changes may include a change in contributions 672, change in beneficiary 674, transfer request 676, withdrawal 678 and rollover 680. All changes in the forms are then completed and submitted online to the bank handling the HSA, at 682.

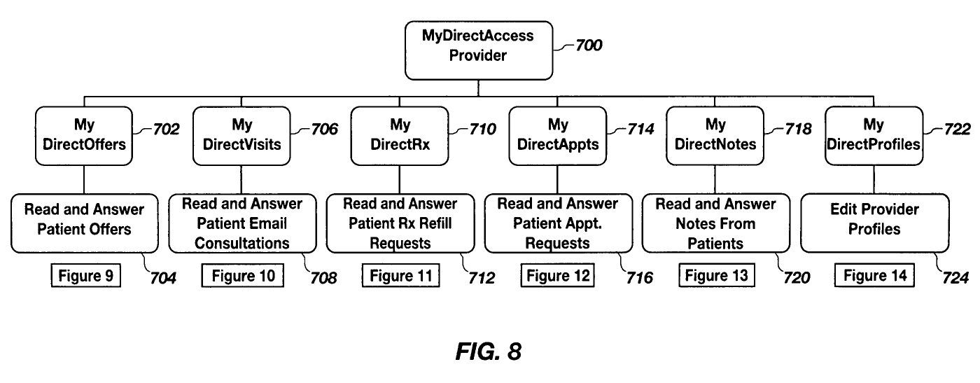

Referring now to FIG. 8, a flow diagram 700 is shown giving an overall view of another format or implementation of the Direct Access System from a healthcare provider viewpoint. The healthcare provider refers to a physician, physician's assistant, nurse, chiropractor, or other healthcare provider. Here, the functions of the system are separated into six different steps, each being explained more fully in subsequent FIGS. These steps and their functions are referred to as MyDirectOffers at 702—the provider reads and answers patient offers at 704, MyDirectVisits at 706—the provider reads and answers patient online email consultations at 708, MyDirectRx at 710—provider reads and answers patient prescription refill requests at 712, MyDirectAppts at 714—provider reads and answers patient appointment requests at 716, MyDirectNotes at 718—provider reads and answers patient notes at 720, and MyDirectProfiles at 722—provider edits provider profiles at 724.

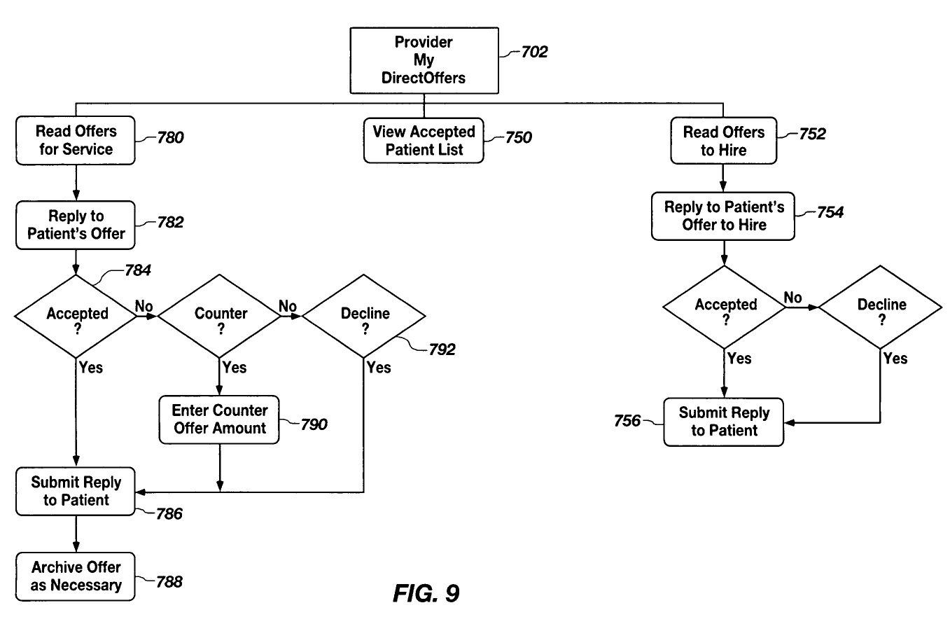

Looking next at FIGS. 8 and 9, the MyDirectOffers services 702-704 are shown in more detail. Using this internet based tool set of the Direct Access System, a selected medical provider is able to receive and read offer requests from member/patients to either engage the medical provider or to request a specific service from the provider. The medical provider may read the request and make a decision to accept, counter, or decline the offer from the member, and the reply is submitted to the member.

At step 750, the provider views an updated patient list, which will change as he accepts new patients. As stated earlier, the user may carry out various searches at step 304 to find a provider that is suitable to the needs of the user, including searches regarding expertise, training, experience, schedule of charges, address, and availability. At step 752, a user submits an offer to hire the provider, which is then read by the provider. A reply is sent by the provider, at step 754, accepting or declining the user's offer at 756.

If the patient has been accepted, he is added to the updated patient list. The patient may then submit an offer for services, which is read by the provider at step 780. The provider then replies to the patient's offer at 782, in which he accepts, declines, or counters the offer. If he accepts the offer at 784, then he submits a reply to the patient at 786, which the provider may archive for future reference at 788. If he submits a counter offer at 790 or declines at 792, these are also submitted to the patient at 786 and archived at 788.

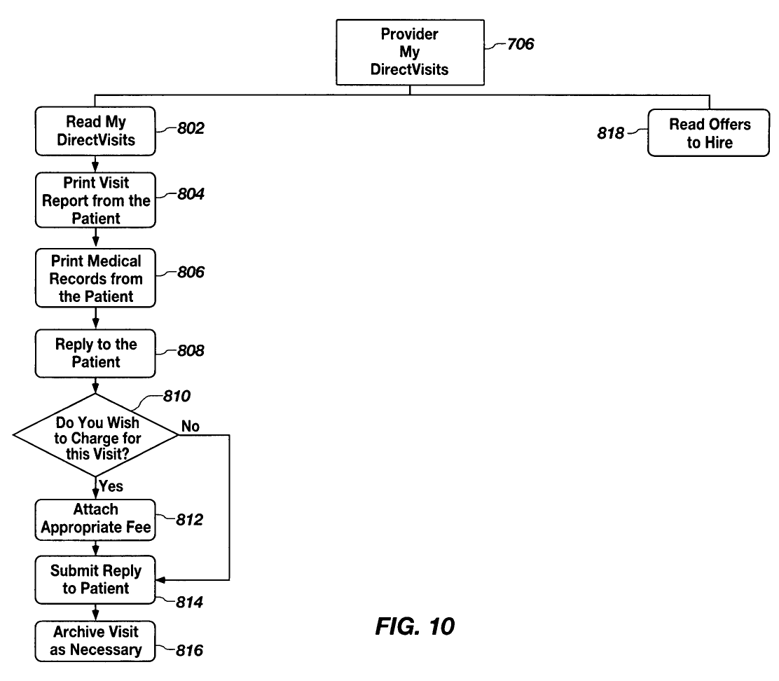

Referring to FIGS. 8 and 10, the MyDirectVisit function 706-708 is shown in greater detail. Using this tool set of the Direct Access System, a selected medical provider is able to receive and read virtual office visits from member/patients. After a patient completes and submits a guided health questionnaire, the provider is able to offer a medically appropriate answer and attach an appropriate fee to be paid by the patient. This service takes place on the secure web messaging portal contained in the Direct Access System internet based tool set.

At step 802, the provider reads a direct online visit from a patient-user, which is printed at step 804. At 806, the provider also prints the medical records of the patient, which are made available to the provider online if they are not already in the doctor's office or database. The provider then studies the online visit and the medical records and makes a diagnosis. He then replies to the patient at 808 with an appropriate treatment and medication. If a charge is to be entered for the service, at step 810, an appropriate fee is attached to his reply at 812, which is then submitted to the patient at 814. The request and reply are archived at 816 to be viewed by the provider at 818.

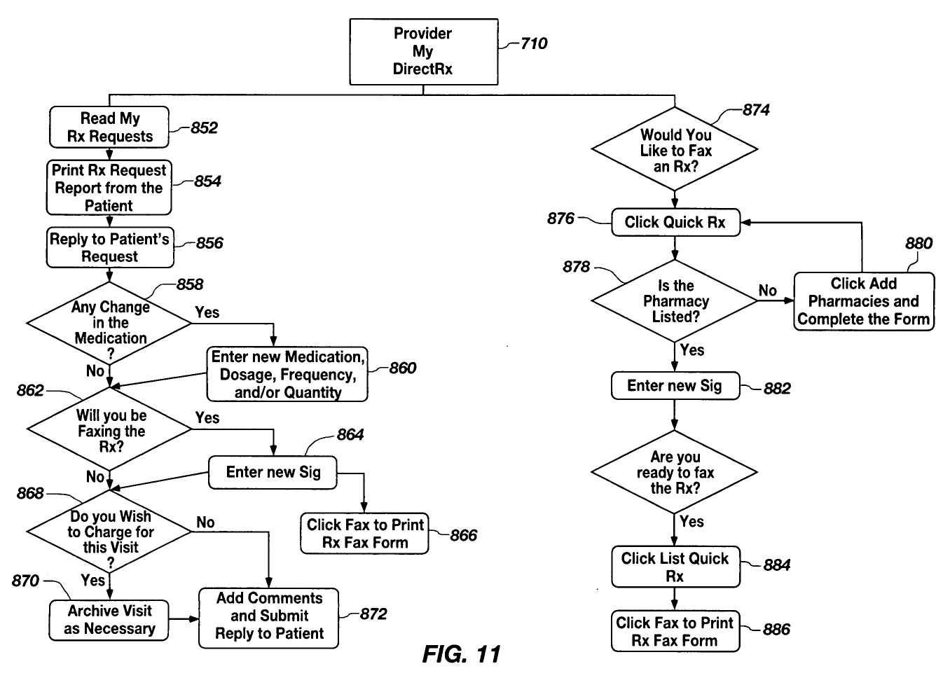

Referring to FIGS. 8 and 11, the MyDirectRx function 710-712 is shown in greater detail. Using this internet based tool set of the Direct Access System, a selected medical provider is able to receive and read virtual prescription requests from a member/patient. The medical provider is able to review information provided by the patient and authorize a refill, change medication or signature, based on this information. The medical provider is also able to process a new prescription request on behalf of the member/patient by completing a fax form to be sent to a pharmacy of the member/patient's choosing.

At step 852, the provider reads a direct online prescription request from a patient-user, which is printed at step 854. At 856, the provider studies the request and replies to the patient with an appropriate prescription. If there is a change in the medication at 858, the new medication, dosage, frequency, or quantity are entered in the patient's records at 860. Next, a decision is made at 862 whether to fax the prescription. A new signature is entered at 864 and the fax form is printed and sent at 866. A decision is made as to whether a charge is to be entered for the service, at step 868. If so, an appropriate fee is attached to his reply at 870, which is then submitted to the patient at 872 with the provider's comments.

At step 874, a determination is made as to whether the medical provider would like to send a fax to a pharmacy of the patient's choosing. The provider clicks a Quick Rx button at 876 to determine whether the pharmacy is listed in the database of the Direct Access System, at 878. If not, the pharmacy is added at 880. If necessary, a new signature is entered into the system at 882. The pharmacy list is accessed at 884, and an appropriate fax is printed at 886.

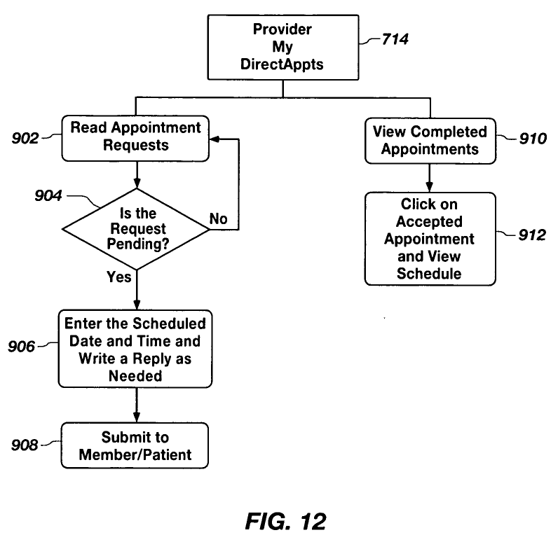

Looking now at FIGS. 8 and 12, the My DirectAppointments function 714-716 is provided in greater detail. A medical provider's view is given of the appointment request function of this internet based tool set of the Direct Access System. A medical provider is able to read and respond to appointment requests made by a member/patient.

At step 902, the selected medical provider reads an appointment request from a patient. At 904, the provider determines whether the request is pending. If so, at 906, the provider enters the scheduled date and time, and writes a reply to the patient as needed. At step 908, this message is submitted to the patient, via the system, such as by an email message. If the request is not pending, the process goes back to read another appointment request, at step 902. The medical provider may also view completed appointments, at step 910. He may also click on accepted appointments and view his schedule at 912.

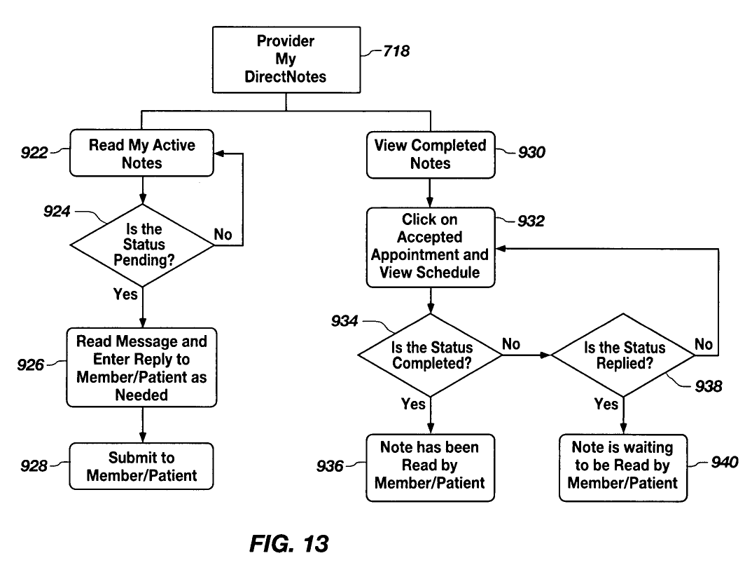

Referring now to FIGS. 8 and 13, the My DirectNotes function 718-720 is shown in greater detail. An internet based tool set of the Direct Access System is shown for viewing provider/patient notes. A medical provider is able to read and respond to notes from a member/patient using this tool set.

At step 922, the provider reads any outstanding active notes received from a member/patient. At 924, a determination is made as to whether the status is pending on a particular note. If so, at 926, the provider reads the message and enters a reply to the member/patient as needed. The message is submitted to the member/patient at 928, in any appropriate fashion, such as via an email or fax message. If the note is not pending, the process goes back to read another active note, at step 922. The medical provider may also view completed notes at step 930. He may also click on accepted appointments and view his schedule at 932. A query is made at 934 as to whether the status is completed. If so, the note has been read by the member/patient, at 936. If not, a query is made as to whether the status is replied, at 938. If yes, the not is waiting to be read by the member/patient, at 940. If not, the process goes back to clicking on an accepted appointment and viewing the schedule, at step 932.

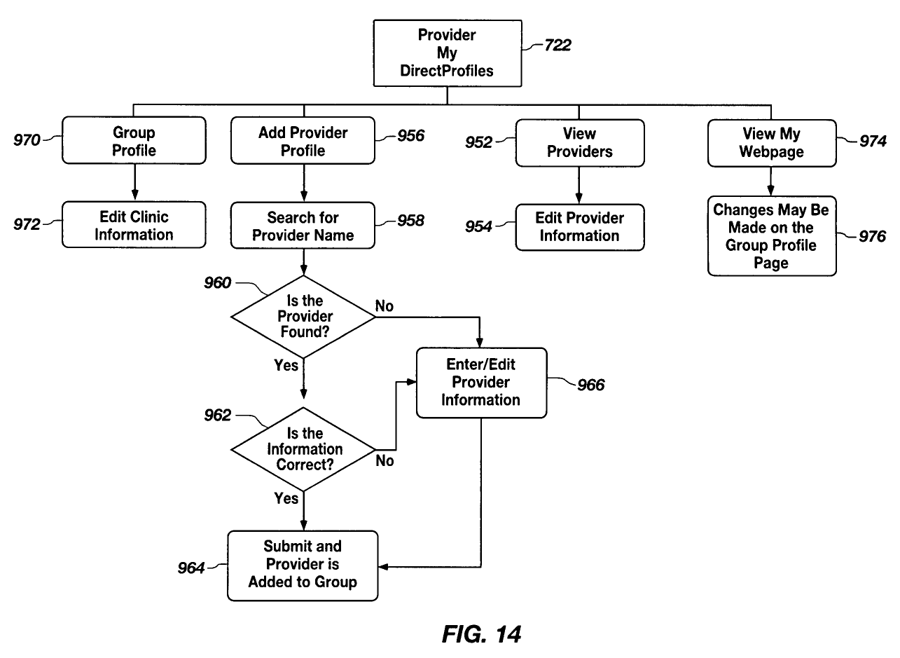

Looking now at FIGS. 8 and 14, the My DirectProfiles function 722-724 is shown in greater detail. A medical provider is able to manage the provider profiles at 950, using this internet based tool set of the Direct Access System. The medical provider is able to add new providers, edit provider information, edit clinic information, and populate a group/clinic personalized website.

At step 952, the provider is enabled to view providers on the database. He may edit the provider information at 954. At 956, the medical provider may decide to add a provider profile to the system. At 958, he searches for the provider name in the system. A query is made at 960 as to whether the provider's name is in the system. If found, a determination is made at 962 as to whether the information is correct. If so, the provider submits the new provider to the group in the database at 964. If not, or if the provider is not found, the provider information is entered or edited in the database, at 966. At 970, the group profile may be accessed, and clinic information may be edited at 972. At 974, the provider may access his webpage and make changes to the group profile page at 976.

While this invention has been described in certain embodiments, the present invention can be further modified with the spirit and scope of this disclosure. This application is intended to cover any variations, uses, or adaptations of the invention as described and/or claimed herein. The application is also intended to cover variations from the present disclosure within known or customary practices in the art to which this invention pertains and which fall within the limits of the appended claims.

What is claimed is:

1. An online healthcare method for providing online health care from a healthcare provider to a patient, comprising:
(a) providing online communication between the patient and the healthcare provider;
(b) providing online diagnosis and treatment by the healthcare provider for the patient; and
(c) providing the patient's medical records online to be accessed by the patient and the healthcare provider for use in the online diagnosis and treatment.

2. The method of claim 1, wherein the online diagnosis and treatment by the provider comprises the patient submitting symptoms and a diagnosis request to the provider.

3. The method of claim 2, wherein the online diagnosis and treatment comprises the provider reviewing the patient's online medical records and the symptoms submitted by the patient, and providing an online diagnosis to the patient.

4. The method of claim 1, further comprising providing an online network of healthcare providers to the patient to select the provider therefrom and storing the patient's selection of the provider.

5. The method of claim 1, further comprising providing an online offer from the patient to the healthcare provider for the patient to pay a predetermined amount for a selected service by the healthcare provider.

6. The method of claim 5, further comprising providing an online reply from the healthcare provider to the patient which accepts, counters or declines the online offer from the patient.

7. The method of claim 1 and further comprising providing online access to a patient's high deductible healthcare insurance program and a health savings account and charging any fees from the healthcare provider against the high deductible healthcare insurance program and the health savings account.

8. The method of claim 1, further comprising providing online financing for the treatment of the patient recommended by the healthcare provider.

9. The method of claim 1, further comprising providing discounts to the patient for the healthcare provider's diagnosis and treatment of the patient.

10. The method of claim 1, further comprising providing online wellness information and records of the patient to assist the patient in promoting his wellness, and to assist the healthcare provider in making the online diagnosis and treatment of the patient.

11. The method of claim 1, further comprising providing online patient advocacy assistance.

12. An online healthcare method for providing online health care from a healthcare provider to a patient, comprising:
(a) providing online communication between the patient and the healthcare provider;
(b) providing an online offer from the patient to the healthcare provider to pay a predetermined amount for a medical procedure desired by the patient; and
(c) providing an online reply from the healthcare provider to the patient accepting, denying or countering the offer from the patient.

13. An online healthcare method for providing online health care from a healthcare provider to a patient, comprising:
(a) providing an online network of healthcare providers;
(b) searching the online network to find a suitable healthcare provider for the patient;
(c) submitting an online request from the patient to hire the healthcare provider; and
(d) submitting an online reply from the healthcare provider accepting or denying the request from the patient.

14. The method of claim 13, further comprising submitting a request from the patient to add a healthcare provider to the network.

15. The method of claim 13, further comprising submitting an online request for an appointment by the patient with the healthcare provider.

16. The method of claim 13, further comprising providing an online discount document to the patient from the healthcare provider to use at the appointment.

17. The method of claim 13, further comprising providing online diagnosis and treatment by the healthcare provider for the patient.

18. The method of claim 17, further comprising providing the patient's medical records online to be accessed by the patient and the healthcare provider for use in the online diagnosis and treatment.

19. The method of claim 13, further comprising providing an online offer from the patient to the healthcare provider for the patient to pay a predetermined amount for a selected service by the healthcare provider.

20. The method of claim 19, further comprising providing an online reply from the healthcare provider to the patient which accepts, counters or declines the online offer from the patient.

21. The method of claim 13, further comprising providing online access to a patient's high deductible healthcare insurance program and a health savings account and charging any fees from the healthcare provider against the high deductible healthcare insurance program and the health savings account.

22. The method of claim 13, further comprising providing online financing for any treatment of the patient recommended by the healthcare provider.

23. An online healthcare system for providing online health care from a healthcare provider to a patient, comprising:
(a) a network of computers providing online communication between the patient and the healthcare provider;
(b) means for providing online diagnosis and treatment by the healthcare provider for the patient; and
(c) means for providing the patient's medical records online to be accessed by the patient and the healthcare provider for use in the online diagnosis and treatment.

24. An online healthcare system for providing online health care from a healthcare provider to a patient, comprising:
(a) a network of computers providing online communication between the patient and the healthcare provider;
(b) means for providing an online offer from the patient to the healthcare provider to pay a predetermined amount for a medical procedure desired by the patient; and
(c) means for providing an online reply from the healthcare provider to the patient accepting, denying or countering the offer from the patient.
